(19) United States
(12) Patent Application Publication
(10) Pub. No.: US 2014/0007455 A1
(43) Pub. Date: Jan. 9, 2014

(54) METHOD AND DEVICE FOR CRUSHING AND DRYING A MATERIAL

(71) Applicant: Erik Backlund, Skelleftea (SE)

(72) Inventor: Erik Backlund, Skelleftea (SE)

(21) Appl. No.: 13/261,708

(22) PCT Filed: Feb. 9, 2012
(86) PCT No.: PCT/SE12/00015

§ 371 Date: Sep. 19, 2013

(30) Foreign Application Priority Data
Feb. 14, 2011 (SE) 1100100-5

(51) Int. Cl. F26B 1/00

(52) U.S. Cl. CPC F26B 1/005
USPC 34/386; 34/60

(57) ABSTRACT

The invention concerns a method and a device for crushing/grinding and drying a material or a material mixture (M), in which a cyclone device (10) is used that comprises an outlet (52) for gaseous medium (G) and an outlet (14) for material (M) crushed/ground and dried in the cyclone device (10). At least a part of the gaseous medium (G) that leaves the cyclone device (10) is recirculated in such a manner that it re-enters into the cyclone device.

The present invention relates to a method in accordance with the preamble of claim 1. The invention also relates to a device.

### BACKGROUND OF THE INVENTION

There is a great need in a number of different contexts for crushing and drying various materials or material mixtures. The crushing and drying of biofuel can be mentioned as a non-limiting example.

### OBJECT OF THE INVENTION

The invention has as an object the making available of a method and a device that are very advantageous in the crushing and drying of different materials. This object is met in that the invention comprises the characteristics indicated in the claims.

### ADVANTAGES OF THE INVENTION

Among the many advantages of the invention, among other things, it can be mentioned that an extremely good crushing and drying result can be obtained with a very low consumption of energy.

### SHORT DESCRIPTION OF THE DRAWINGS

FIG. 1 is a longitudinal section through a cyclone device that can be used to carry out the invention.

FIG. 2 is an enlargement of a detail shown in FIG. 1.

FIG. 3 is a schematic illustration of the invention.

### DETAILED DESCRIPTION OF A SHOWN EXEMPLARY EMBODIMENT

FIG. 1 shows a cyclone device 10 that can be used for the method in accordance with the invention. It has a housing with a cylindrical part 11 with a tangential inlet from a feed line 12 and the cylindrical part merges into a conical part 13 that has a bottom outlet 14. A vortex collector in the form of a cylindrical tube 15 that can have a conical end 16 extends down through the cap 17 of the cylindrical part and functions as an air outlet to the atmosphere. The axial position of the vortex collector can be adjusted as indicated with jacks 18, 19. A constriction for the outlet is formed by a cone 20 in such a manner that an annular outlet slot 21 is formed that can be adjusted in that the axial position of the cone 20 is adjusted relative to the tube 15 with the screw 22.

When air or another gas is blown into feed line 12 by a fan (not shown), a downwardly-directed vortex is formed that then turns and forms a central, upwardly rising vortex that is trapped by vortex collector 15. The dotted lines 30 show the limit between overpressure on the outside around it and the underpressure on the inside around it.

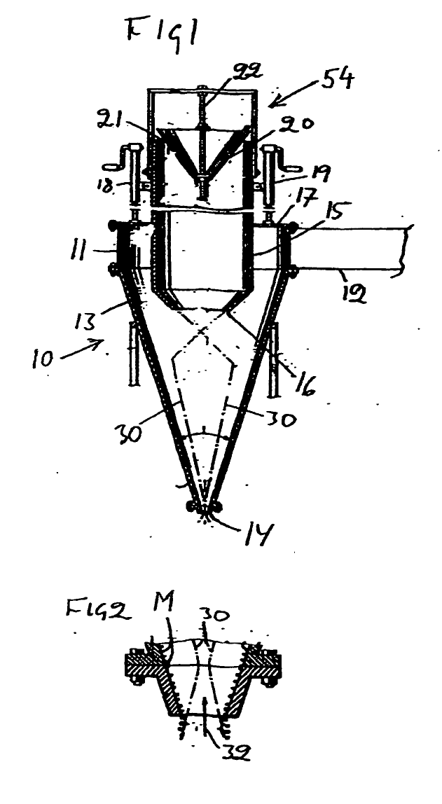

The bottom outlet 14 is shown in an enlarged manner in FIG. 2, where it is apparent that material M that is supplied with the blown-in air into feed line 12 is deposited on the conical wall and travels downward along the wall and out through the outlet. As is apparent in the figure by the dotted lines 30 that are also found in FIG. 1, there is overpressure along the wall but an underpressure in the centre of the outlet, so that air flows in as indicated by the arrow 32, for which reason material can alternatively be introduced there instead of in the air feed line 12. The outlet 14 can be modified to be annular. The cyclone and its properties are not described in detail since a cyclone of this type is described in detail in U.S. Pat. No. 5,236,132, U.S. Pat. No. 5,598,979 and U.S. Pat. No. 6,517,015 B2. Reference is made to these publications.

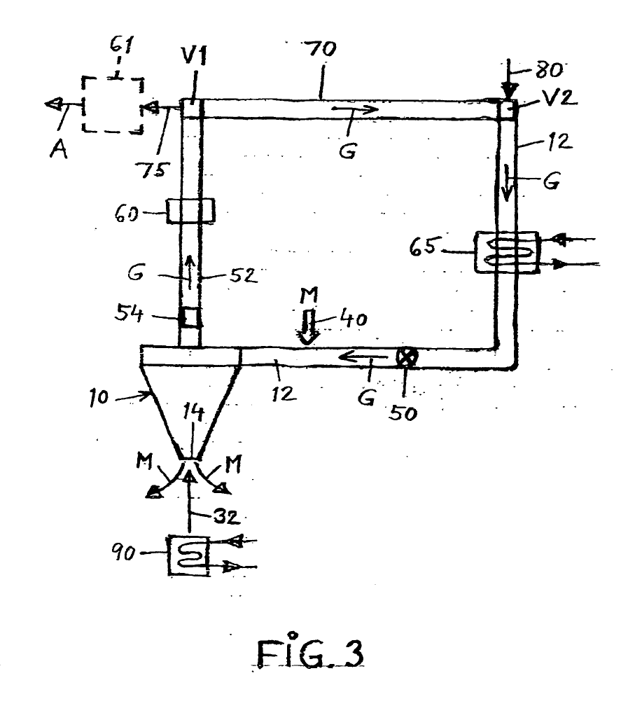

A material or a material mixture M is supplied to a cyclone device 10 at a material infeed position 40 into the feed line 12 (see FIG. 3), whereby the cyclone device separates the material mixture into smaller fractions and dries the material mixture. The ground and dried material mixture M leaves the cyclone device 10 via the outlet 14.

A preferably speed-regulatable fan 50 blows air or another gas G into the feed line 12, as is apparent from FIG. 3. After acting in the cyclone device 10 the gas G leaves the cyclone device through an outlet line 52 in which a regulatable throttle valve 54 is arranged for adjusting the operating properties of the cyclone device. The gas G that leaves the cyclone device through the outlet line 52 has acquired a higher moisture content in conjunction with the grinding and drying of the material mixture M in the cyclone device 10. The normal method is that the gas G can pass out into the atmosphere, possibly via a purification device 60 that removes material remnants from the gas G.

The gas G is initially supplied to device 10 via a feed line 12 in which a heat exchanger 65 is arranged, whereby, for example, waste heat from an industrial process can be utilized.

According to the invention a communication line/recirculation line 70 is arranged between the inlet line 12 and outlet line 52. Valves V1 (first valve) and V2 (second valve) for regulating and directing the gas flow G are arranged as indicated in FIG. 3.

According to the invention the valves V1 and V2 are placed in such a manner that a desired amount of the gas G that leaves the cyclone device 10 is recirculated to the infeed line 12 in order to again pass through the cyclone arrangement 10. The recirculation can continue until the gas G achieves a desired temperature and moisture absorption capacity, whereby the gas G is evacuated by adjusting the valve V1 to the desired extent to, for example, the atmosphere A via, for example, a purification device 61.

The just-cited recirculation can thus be partial by adjusting the valves V1 and V2 in such a manner that only a partial amount of the gas G is recirculated, whereby a limited amount of gas G is evacuated via the gas outlet 75 and a limited amount of gas G is filled in via the gas inlet 80.

Even a total recirculation can of course occur at desired time periods as well as an omitted recirculation at desired time periods.

The recirculation in accordance with the invention makes possible a very great savings of energy and the heat exchanger 65 makes possible an addition of heat that further increases the savings of energy.

An optimization of energy from the standpoint of operating expenses and utilizing of energy can be optimized by temperature measuring, air humidity measuring and flow measuring at purposeful locations.

Adjustments of the valves V1 and V2 together with the regulation of the speed of the fan 50 make possible an optimal utilization of energy.

In order to obtain a good basis for measuring, sensors and measuring equipment are distributed within the plant.

The first valve V1 and the second valve V2 preferably operate synchronized in their movement pattern so that the emission of gas and the admission of gas are harmonized in an intended manner.

An optimized regulating process for the recirculation can be brought about in a simple manner by a number of sensors and indicators and suitable valve control equipment.

It is apparent that in a simpler embodiment certain components such as, for example, heat exchangers and purification device can be omitted.

With a view to further heat the gas G a heat exchanger 90 can furthermore be arranged at the outlet of the cyclone device, where a gas intake takes place. Waste heat can also be utilized here.

An extra preheating of the inlet gas is also occasionally advantageous.

It is also expedient to arrange equipment for regulating the system pressure of the circulating gas.

The invention can of course be varied in that a replacement takes place by functionally equivalent components.

Thus, the invention is not limited to that which is shown and described but rather modifications and variations are of course possible within the framework of the following claims.

1. A method for crushing/grinding and drying a material or a material mixture (M), in which a cyclone device (10) is used that comprises an outlet (52) for gaseous medium (G) and an outlet (14) for material (M) crushed/ground and dried in the cyclone device (10), characterized in that at least a part of the gaseous medium (G) that leaves the cyclone device (10) via an outlet line (52) is recirculated in such a manner that it re-enters into the cyclone device (10) via a communication line (70) and an inlet line (12), and that the gas flow of the communication line (70) is regulated by two valves (V1, V2).

2. The method according to claim 1, characterized in that the gaseous medium (G) is preheated before it arrives at the cyclone device (10).

3. The method according to claim 1, characterized in that preheated, gaseous medium (G) is supplied to the cyclone device (10) at its material outlet (14).

4. The method according to claim 1, characterized in that a fan (50) is used for regulating the gas flow.

5. The method according to claim 1, characterized in that sensors or transmitters are arranged in the gas flow for mapping the degree of liquid saturation, pressure and temperature in the recirculated gas so that the emission of gas from the gas flow can be optimized as regards the function and the consumption of energy.

6. The method according to claim 5, characterized in that accompanying particles of material are separated from the gas at the gas emission by at least one purification device (60).

7. A device for grinding/crushing and drying a material or a material mixture (M), which device comprises a cyclone arrangement (10) that comprises an outlet (52) for gaseous medium (G) and an outlet (14) for material ground/crushed and dried in the cyclone device, characterized in that the device comprises a communication line (70) between an inlet line (12) for a gas flow and an outlet line (52) for a gas flow, that a first valve (V1) is arranged for regulating a gas flow from the outlet line (52) to the communication line (70), and that a second valve (V2) is arranged for regulating a gas flow from the communication line (70) to the inlet line (12).

8. The device according to claim 7, characterized in that the device comprises at least one heat exchanger (65, 90) for the transferring of heat to the gas flow.

9. The device according to claim 7, characterized in that the device comprises a fan (50) for propelling the gas flow.

10. The device according to claim 9, characterized in that a material supply device (40) is arranged in the direction of the gas flow after the fan (50) for propelling the gas flow.

11. The method according to claim 2, characterized in that preheated, gaseous medium (G) is supplied to the cyclone device (10) at its material outlet (14).

12. The method according to claim 2, characterized in that a fan (50) is used for regulating the gas flow.

13. The method according to claim 3, characterized in that a fan (50) is used for regulating the gas flow.

14. The method according to claim 2, characterized in that sensors or transmitters are arranged in the gas flow for mapping the degree of liquid saturation, pressure and temperature in the recirculated gas so that the emission of gas from the gas flow can be optimized as regards the function and the consumption of energy.

15. The method according to claim 3, characterized in that sensors or transmitters are arranged in the gas flow for mapping the degree of liquid saturation, pressure and temperature in the recirculated gas so that the emission of gas from the gas flow can be optimized as regards the function and the consumption of energy.

16. The method according to claim 4, characterized in that sensors or transmitters are arranged in the gas flow for mapping the degree of liquid saturation, pressure and temperature in the recirculated gas so that the emission of gas from the gas flow can be optimized as regards the function and the consumption of energy.

17. The method according to claim 11, characterized in that a fan (50) is used for regulating the gas flow.

18. The method according to claim 11, characterized in that sensors or transmitters are arranged in the gas flow for mapping the degree of liquid saturation, pressure and temperature in the recirculated gas so that the emission of gas from the gas flow can be optimized as regards the function and the consumption of energy.

19. The device according to claim 8, characterized in that the device comprises a fan (50) for propelling the gas flow.

20. The device according to claim 19, characterized in that a material supply device (40) is arranged in the direction of the gas flow after the fan (50) for propelling the gas flow.
